(19) United States
(12) Patent Application Publication
(10) Pub. No.: US 2010/0169242 A1
(43) Pub. Date: Jul. 1, 2010

(54) MULTIPLE CARRIER MAIL SORTING SYSTEM

(76) Inventors: Edilberto I. Salazar, Brookfield, CT (US); Robert A. Cordery, Danbury, CT (US); Leon A. Pintsov, West Hartford, CT (US); Richard Schoonmaker, Wilton, CT (US); Boris Rozenfeld, New Milford, CT (US); David W. Beckstrom, Milford, CT (US)

Correspondence Address: PITNEY BOWES INC., 35 WATERVIEW DRIVE, MSC 26-22, SHELTON, CT, 06484-3000, US

(21) Appl. No.: 12/345,587

(22) Filed: Dec. 29, 2008

(51) Int. Cl. G06F 17/00; B07C 3/14

(52) U.S. Cl. 705/408; 209/584

(57) ABSTRACT

Systems and methods including mailing machines configured to selecting a route and carrier or carriers for delivery of the mail and for finishing the mail according the selection are described. In one illustrative configuration, the mailing machine tags mail pieces according to the result of a carrier selection process and sorts the outgoing mail by carrier.

### FIELD OF THE INVENTION

The illustrative embodiments described in the present application relate generally to preparing mail and more particularly in certain configurations to selecting a route and carrier or carriers for delivery of the mail and finishing the mail according the selection.

### BACKGROUND

Postal systems in many countries have been monopolies with a government postal agency charged with running the national postal system and providing universal delivery service for letters to each household. In some countries, express parcel/letter shipping services are exempt from the national monopoly resulting in additional carrier options for certain segments of mail.

In certain regions, national postal services are relinquishing their letter delivery monopoly and opening up letter delivery to competition in a so-called liberalization of the postal systems. The proliferation of service providers, offered services, carriers, carrier requirements, and electronic delivery options has resulted in a multitude of delivery options for a mailing. For example, a plurality of carriers may be potentially available to deliver a mailing in a given country or region. Additionally, user preferences may contribute to the complexity and possible delivery options. Here, mail in a broad general sense refers to postcards, envelopes, letters, flats and parcels.

The emergence of multiple carriers in a mailing system presents additional complexity to the mailer with regards to the optimum choices with regard to mail delivery. Mailers that wish to use multiple carriers must typically manually decide which mail to induct with each separate carrier and then use separate mailing machines to process the outgoing mail assigned to each carrier.

Accordingly, it would be desirable to have equipment and systems to efficiently determine what delivery choices should be made with regard to a particular mail piece and to efficiently process the outgoing mail in accordance with such choices.

### SUMMARY

The present application describes illustrative embodiments of systems and methods to preparing mail and more particularly in certain configurations to selecting a route and carrier or carriers for delivery of the mail and finishing the mail according the selection. In one illustrative configuration, a mailing machine includes a selection engine for determining carrier selection with regard mail pieces being processed. The mailing machine associates an indication of the carrier selection with the mail piece such as by physically sorting to carrier bins or by marking or printing on the mail piece or associating data with a mail piece identifier. The mailing machine optionally includes a sorter to sort the mail according to carrier selection.

In another illustrative configuration, an alternative mailing machine receives tagged mail pieces that have carrier related data associated with the mail piece such as by identifier or printed data mark. The mailing machine includes a selection engine for determining carrier selection with regard to the mail pieces being processed and the received carrier related data. The mailing machine optionally associates an indication of the carrier selection with the mail piece such as by printing a second mark on the mail piece. The mailing machine optionally includes a multiple-carrier, multiple-PSD postage meter and finishes the mail piece by selecting an appropriate carrier postal security device and applying a postage payment indicium. The mailing machine may include a carrier selection sorter.

In yet another illustrative configuration, an alternative mailing machine includes a route selection subsystem for selecting at least two carriers for sequential delivery of the mail piece to the ultimate destination by way of an intermediate location. The mailing machine optionally associates an indication of the multiple carrier selection with the mail piece such as by printing one or more marks on the mail piece. The mailing machine also optionally includes an address overprint system for providing intermediate delivery instructions. The mailing machine optionally includes a sorter to sort the mail according to carrier selection.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a schematic diagram of a mailing processing system according to an illustrative embodiment of the present application.

FIG. 2 is a schematic diagram of a mailing machine having a carrier selection engine according to an illustrative embodiment of the present application.

FIG. 3 is a schematic diagram of a mail piece printed with a postal indicium associated with a selected postal security device according to an illustrative embodiment of the present application.

FIG. 4 is a schematic diagram of a mail piece printed with two postal indicia, each associated with a separate selected postal security device and an overprint address label according to another illustrative embodiment of the present application.

FIG. 5 is a flow chart describing a process for selecting a carrier for a mail piece and processing the mail piece according to an illustrative embodiment of the present application.

### DETAILED DESCRIPTION

The illustrative embodiments of the present application describe systems and methods for preparing mail and more particularly in certain configurations to selecting a route and carrier or carriers for delivery of the mail and finishing the mail according the selection. In one illustrative configuration, a mailing machine includes a selection engine for determining carrier selection with regard mail pieces being processed. The mailing machine associates an indication of the carrier selection with the mail piece such as by physically sorting to carrier bins or by marking or printing on the mail piece or associating data with a mail piece identifier.

The present single carrier, multiple-rating mail processing systems already require a fair amount of manual decision making of the mailer. As the carrier choices increase with multiple carrier capability and a myriad of rating structures under each, the decision making requirements increase significantly. Accordingly, there is a need to provide a level of carrier selection assistance. Thus the mailing machine described in this embodiment is configured to sort incoming mail to the desired carrier and underlying rating structures among a plurality of carriers offered in the system, and then eventually though a postage meter with a plurality of PSDs or physical bins for further processing. In one configuration, carrier selection is automatically performed by the mailing machine by obtaining initial carrier selection related data using the mail piece. The initial carrier selection related data may be encoded on the mail piece as in a barcode or associated with the mail piece such as linked by a locally unique mail piece identifier or other suitable system.

The initial carrier selection related data may include a mailer's carrier selection preference naming a carrier (if available for a particular class of service), an indication that lowest cost or fastest service is desired, or a carrier preference by geographic region among other data. The initial carrier selection related data may be encoded in a 2D barcode or may comprise a printed colored mark such as a dot or a small colored label. The initial carrier selection preference data may be associated with a particular sender identity or group code such as a company department. Moreover, the initial carrier selection preference data may be associated with the sender identity and may then be associated with regulatory and delivery option provisions associated with that address. Many known carrier selection methodologies may be adapted for use in the systems described here using appropriate parameters for the carrier selection engine and the appropriate marking/sorting systems described herein. The mailing machine may be in the form of a standalone kiosk, or a component of a mailing system such as a modified multi-carrier DM 500 mailing machine.

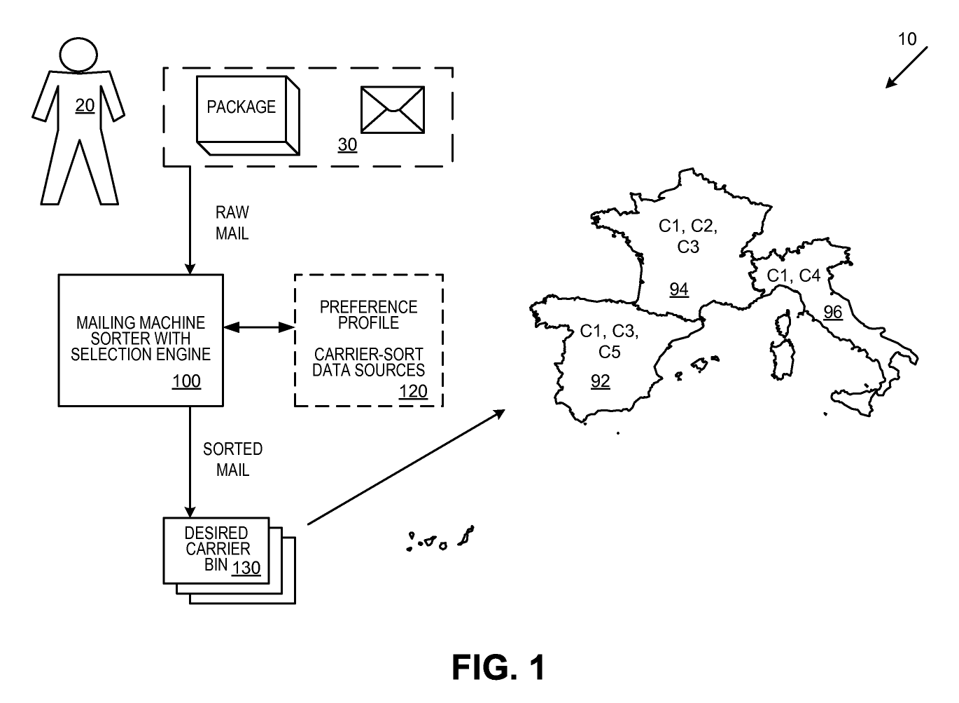

Referring to FIG. 1, a schematic diagram of a mailing processing system 10 according to an illustrative embodiment of the present application is shown. The mailer or user 20 is an individual or company employee who would like to send mail pieces 30 to various destinations using various available carriers in an efficient and effective manner according to certain preset criteria, wherein the preset criteria may be overridden. Here, mail in a broad general sense refers to postcards, envelopes, letters, flats and parcels. Initial carrier selection data may be applied to the mail 30 before processing such as by printed barcode, color label or other data association.

The mailing machine 100 includes a carrier selection engine and sorter used to obtain and process the optional initial carrier selection data with carrier preference profiles 120 and carrier rating/data sources 120 to select a carrier. The carrier-selected sorted mail is then output into desired carrier bins. In the Unites States (not shown), the national postal service is the United States Postal Service (USPS) C0. In Spain 92, the national postal service is Correos de España C5. In France 92, the national postal service is La Poste C2. In Italy 96, the national postal service is Poste Italiane C4. Other carriers include the international parcel shipping company United Parcel Service (UPS) C1 and the successor of the former national postal service monopoly of Germany known as Duetche Post C3. Preference data and carrier data including, price, availability, reliability and disruptions, etc. are maintained in databases for the available carriers. The databases described or referred to herein regarding preference profiles and carrier sort data sources reside on a relational database such as ORACLE databases running on SUN servers. Third party data sources may also be referenced directly through information brokers using appropriate networks such as secure INTERNET connections.

The mailing machine 100 also preferably includes a multi-carrier capable physical characteristic measurement subsystem. The mailing machine measures weight and size as appropriate for multiple carriers. For example, certain carriers determine size based upon length and width as opposed to girth. Alternatively, physical measurements are performed by one or more machines upstream of the mailing machine. In such an alternative, the physical measurements may then also be encoded and printed on or otherwise associated with the mail piece as a form of initial carrier selection data. Additionally, other physical characteristics such as the value of the contents, hazardous classification or perishable date data may also be encoded and printed on or otherwise associated with the mail piece as a form of initial carrier selection data.

The carrier selection engine may simply select a carrier using user 20 input from a user interface (not shown) connected to the mailing machine. However, the mailing machine 100 may efficiently automatically select or suggest to the user a carrier for the user using the any initial carrier selection data, any carrier preference profile data and carrier-sort data sources. The preference profile may use data such as price, service availability (or compatible class of service) and carrier congestion/delay data obtained from the carrier or other third party that has such data. The selection engine may use a most likely to be reliable delivery date guarantee determination based upon guarantee history data. The system may select a carrier based upon availability of a discount from a particular carrier within an acceptable time frame for the desired delivery date. Additionally, the system may select a carrier based upon a mail piece discount aggregation opportunity available for one or more of the carriers. Additionally, any available known carrier selection system and method may be adapted to the embodiments described herein to allow a wide range of carrier selection possibilities.

Moreover, the carrier selection methodology may comprise a system and method for routing selection using statistical data such as described in the illustrative embodiments of commonly-owned, co-pending U.S. patent application Ser. No. 11/844,437, filed Aug. 24, 2007 by Matthew J. Campagna, et al. under attorney docket no. G-325, such patent application incorporated herein by reference in its entirety. The selection engine described therein may be adapted for use herein including all of the types of parameter information described and referred to there along with the route scoring and selection methods. The one or more information brokers used therein may be resident in a separate server or located in one or more of the remote data centers connected to mailing machine 100 associated with one or more of the relevant carriers.

As described, in addition to the initial carrier selection related data that may be included on the mail piece, the mailing machine user 20 may have detailed preference profiles stored in database 120. For example, the user preference profiles may include a mailer's carrier selection preference naming a carrier (if available for a particular class of service), an indication that lowest cost or fastest service is desired, or a carrier preference by geographic region, etc. All of the parameter information described or referred to in the '437 application for use with a selection engine may be utilized.

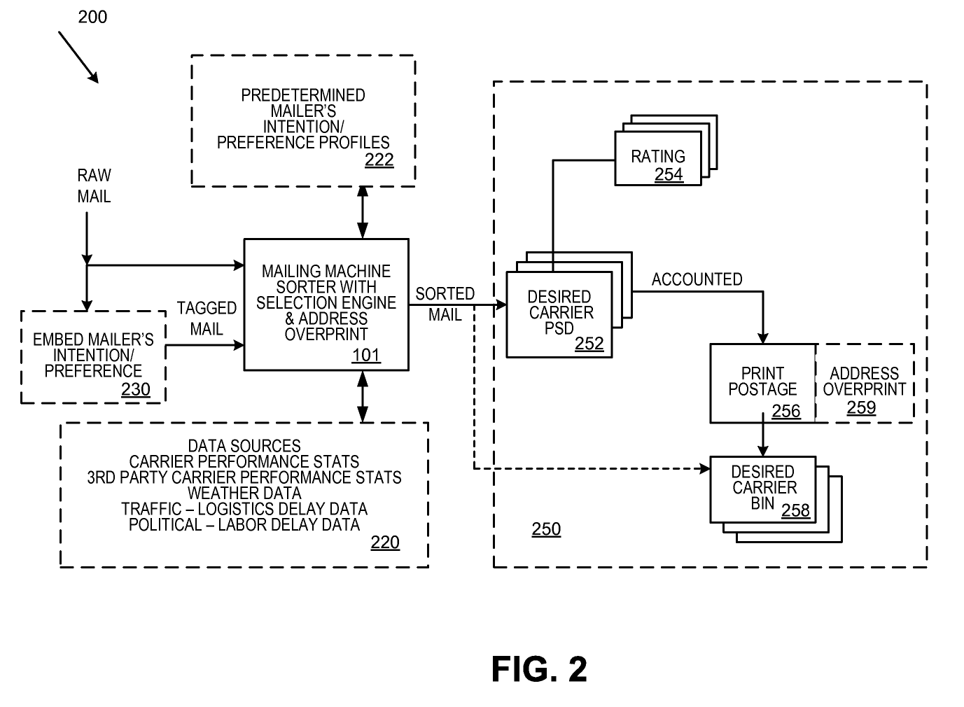

Referring to FIG. 2, a schematic diagram of a mailing machine 200 having a carrier selection engine according to an illustrative embodiment of the present application is shown. The mailing machine 101 may receive raw mail directly or may receive tagged mail from an upstream process such as another mailing machine that tags mail with initial carrier selection data. Accordingly, mailing machine 101 includes a CCD camera for reading encoded or text carrier preference data including barcodes, color marks or labels or text including address and return address text. The mailing machine receives data input from the predetermined mailer's intention/preference profile database 222 and the internal/external data source databases 220. The data sources include carrier performance statistics, 3^{rd} party carrier data, weather data, traffic and logistics system delay data such as airport delays and political and labor delay related information.

The selection engine selects the carrier based upon a cascading decision tree. Initially, the user at the highest priority may select a carrier using the user interface. Next, a carrier selection retrieved from the initial carrier selection data will be used if the carrier ad service is available. Next, the initial carrier selection data, profile data 222 and other data sources 220 are combined as determined in a configurable decision matrix in the mailing machine 101. Since the preference profiles 222 may be modified and since the data sources 220 are dynamic, the same mail piece might be routed differently on different days, such as to avoid labor, traffic or weather delays.

The mailing machine 101 may then feed the selection engine outputted sorted mail to desired carrier bins 258. The mailing machine 101 optionally includes a multi-carrier, multi-PSD postage meter module 250. The selection engine outputted sorted mail would then be fed into the postage meter module 250. The sorted mail may be tagged with a code that directs the postage meter module to apply the appropriate postage indicium for the carrier/class/rating data. For example, the USPS or carrier C1 is selected and an appropriate mark or barcode applied by mailing machine 101. Postage meter module 250 reads the barcode, selects the appropriate PSD 252, the appropriate rate 254 and accounts for and prints the postage with printing module 256. The postage meter module 256 then feed to the sorter into desired carrier bins 258. Alternatively, sorted mail is fed into a separate multi-carrier postage meter or multiple single carrier, single PSD postage meters.

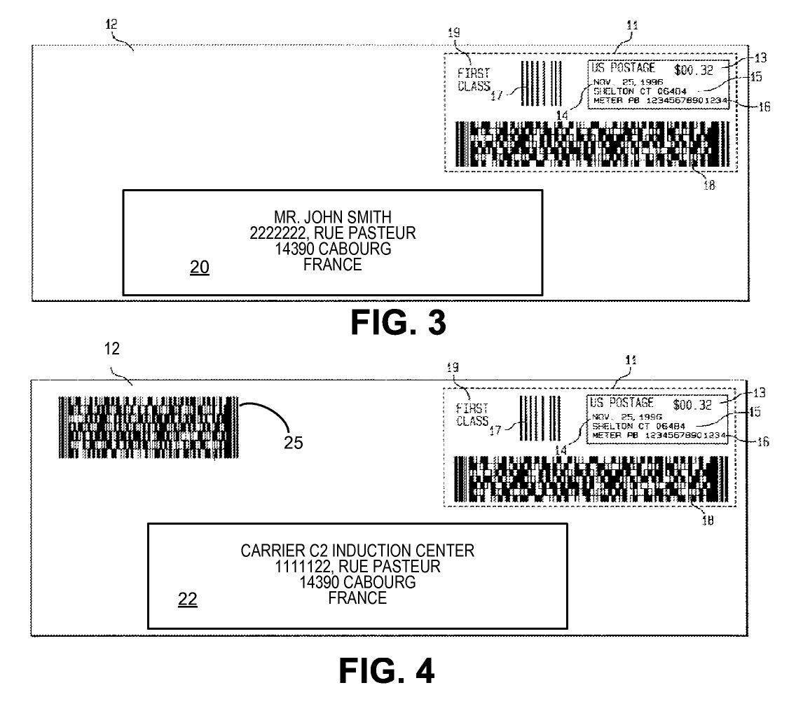

The mailing machine may make a single carrier selection and produce a single carrier mail piece as shown in FIG. 3, or may instead select a multiple-carrier route and produce an appropriate mail piece such as that shown in mail piece of FIG. 4. If a two carrier route is selected, mailing machine 101 may use an address overprint to indicate an intermediate delivery point such as the induction facility of the second carrier. An “over label” may be printed and applied to the mail in a similar fashion to the “yellow” change of address semi-permanent address labels used by the USPS in postal address change notification applications. Additionally, permanent labels or other marking systems may be used as appropriate to modify the mail piece such as for the carrier C2 delivery systems. An optional address overprint printer 259 may be used and the reverse side of the envelope may be used. Module 259 may be another label printer that prints removable address labels that are manually attached to the mail.

In this illustrative example, mailing machine 101 comprises a modified version of the OLYMPUS II incoming mail sorter available from Pitney Bowes Inc. of Stamford Conn., and the postage meter module comprises a modified DM 500 mailing machine. The PSDs support the appropriate currency denomination required by each carrier. The mailing machine 101 and its user interface controller may also be connected to a co-located computer such as a DELL OPTIPLEX INTEL/WINDOWS PC (not shown) and/or a remote data center or multiple data centers over the INTERNET (not shown). Mailing machine 101 includes a processor/user interface with a communications subsystem (not shown) for connection to a local network, remote data center and the INTERNET.

Referring to FIG. 3, a schematic diagram of a mail piece 12 printed with a postal indicium 11 associated with a selected postal security device according to an illustrative embodiment of the present application is shown. Mail piece 12 includes a USPS Compliant Information-Based Indicia (IBI) 11. Such indicium 11 is printed by mailing machine 100 according to the format specified when the carrier selected is the USPS. The postal indicia 11 contains a postage value, such as dollar amount 13, the date 14 that the postal indicia was affixed to the mail piece, the origin the mail piece was mailed from 15, the postal meter serial number 16, a FIM code 17 and a 2D IBI bar code 18. Some of the human readable information described above is also included in the digitally signed barcode 18 in machine readable form. Some of the information provided in the indicium 11, such as PSD ascending and descending register values, is included only in the barcode. The IBI Indicia 11 also contains a service class indication 19 for the mail piece. For example, this particular mail piece is being sent by USPS FIRST CLASS MAIL service. The mail piece 10 also includes a destination address field 20. Optionally, the mail piece 12 would include return address information. The mailing machine would apply a carrier selection process and then apply the appropriate indicia format.

Referring to FIG. 4, a schematic diagram of a mail piece 24 printed with two postal indicia 11, 25, each associated with a separate selected carrier according to another illustrative embodiment of the present application is shown. This embodiment illustrates multiple carrier processing with a first carrier delivering to a second carrier that then delivers the mail piece to the final destination. The first carrier is not necessarily made aware of the final destination. If the mail piece 24 were to include optional return address information, barcode 25 would be located below that field. Each carrier provides format definitions regarding its primary indicia format and any intermediate indicia format if intermediate processing is available.

The carrier selection used here is illustrative of a preset business rule. Here, the user does not wish to use UPS C1 for delivery in FRANCE. However, the mailing machine 101 selection engine determines for example, that the USPS is the cheapest first leg and always uses UPS C2 for mail pieces that it delivers to FRANCE. The user would like to use La Poste for delivery directly to FRANCE, but the rates are cheaper if the route is broken into two legs, with the USPS making the first delivery to the La Poste induction facility in FRANCE and then having La Poste delivering to the final destination. Accordingly, for any France bound letters, the mailing machine 101 applies a USPS indicium 11 for USPS delivery to carrier C2 and for further processing according to a preset arrangement with carrier C2 (La Poste this example) using postage payment indicia format 25.

Here, Carrier C2 has an intermediate processing indicia definition in addition to its normal indicia definition. Here, when used as an intermediary, carrier C2 defines postal indicia format 25 (illustrated as a 2D barcode) to include postage payment evidencing and also required destination information such as a unique mail piece Identifier to be used with an out-of-band electronic process to procure destination data or the actual destination data that may be encrypted or otherwise cryptographically secured. For example, the first carrier may not be able to read and/or decode the information in barcode 25.

The initial address field 22 is printed on an over-label to provide a delivery address to the first carrier. In this case, the first delivery address is to the inducting (intake) facility of the second carrier. The second carrier will obtain payment and delivery information from postal indicium 25 that includes a final destination address and appropriate evidence of payment from the second carrier inducting center to the final destination. The second carrier can then process the mail piece as required to deliver the mail piece to the final destination. For example, the “over label” may be removed to reveal final destination address 20.

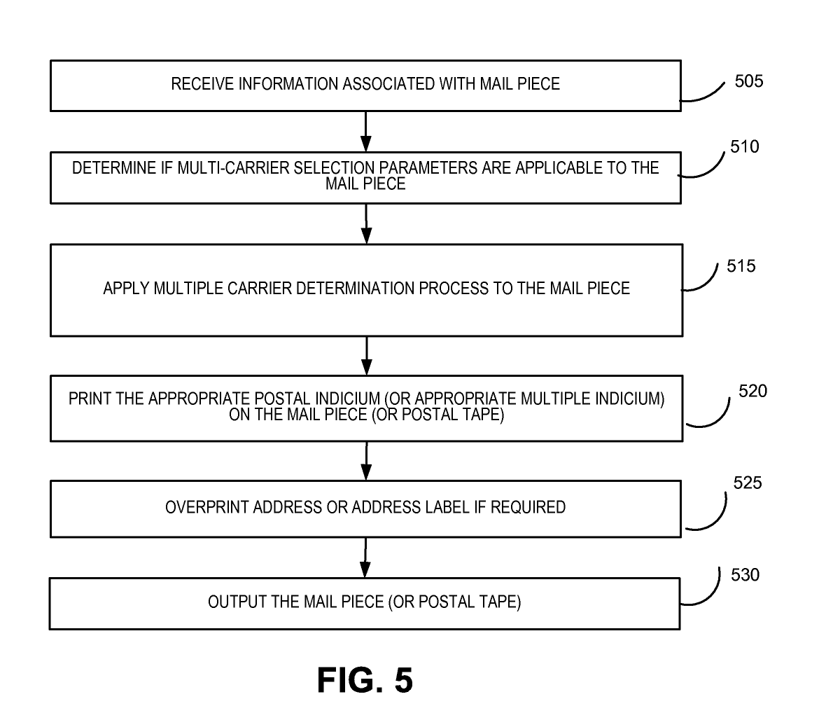

Referring to FIG. 5, a flow chart describing a process for selecting a carrier for a mail piece and sorting/marking and/or finishing the mail piece according to an illustrative embodiment of the present application is shown. In step 505, the process starts and receives information associated with the mail piece. The process may receive that information from a user, from a preference profile or from reading information on the mail piece such as from a marking applied by an upstream mailing machine or from reading a code or text on the mail piece using a barcode reader or OCR scanner. In step 510, the process determines if multi-carrier selection parameters are applicable to the mail piece. In step 515, the process applies the multiple carrier determination logic. As described above, a destination in FRANCE may trigger a dual carrier process. In step 520, the process prints the appropriate multiple indicium on the mail piece or related postal tape. In step 525, the process prints an overprint address label and in step 530, the process outputs the mail piece such as into an appropriate selected first carrier output bin.

The processes described herein are programmed in the appropriate assembler language for the CPU processor used such as the RENASAS SH series processors or the INTEL ATOM processors. Alternatively, the C or C++ programming language or other appropriate higher level language may be utilized to create the programs resident in the program memories of mailing machine 100, 100 and postage meter module 250. The processors run on real-time or other operating systems such as WINDOWS SERVER, QNX, embedded LINUX or WINDOWS CE stored in memory. The databases described are implemented using ORACLE database software running on SUN servers. Mail pieces as used herein may include a wide range of material such as postcards, letters, envelopes, flats and postal tape for application to a parcel.

Commonly-owned, co-pending patent application Ser. No. ______ (Attorney Docket No. G-443), entitled “MULTIPLE CARRIER MAILING MACHINE” and filed contemporaneously herewith by Richard Schoonmaker, et al. is incorporated herein by reference in its entirety. Any of the embodiments therein or portions thereof, specifically carrier selection and indicium printing methods, may be combined with the embodiments herein as would be known by one of skill in the art practicing the teachings herein.

A number of embodiments of the present invention and relevant alternatives have been described. Nevertheless, it will be understood that various modifications may be made without departing from the spirit and scope of the invention. Other variations relating to implementation of the functions described herein can also be implemented. Accordingly, other embodiments are within the scope of the following claims.

We claim:

1. A mailing machine for printing an indication of carrier selection preference on a mail piece comprising:
a printer subsystem having at least one print head for printing the indication of carrier selection preference on the mail piece;
a first processor operatively connected to the printer subsystem; and
wherein the first processor is configured to select a first carrier from a plurality of available carriers and to control the printer subsystem to print the corresponding indication of carrier selection preference on the mail piece.

2. The mailing machine according to claim 1, wherein,
the first processor is configured to select the first carrier using input obtained from reading a destination address printed on the mail piece.

3. The mailing machine according to claim 1, wherein,
the first processor is configured to select the first carrier using input obtained from a co-located processor.

4. The mailing machine according to claim 1, wherein,
the first processor is configured to select the first carrier using input obtained from a remote data center.

5. The mailing machine according to claim 1, further comprising:
an optical sensor operatively connected to the first processor, wherein,
the first processor is configured to select the first carrier using input obtained from using the optical sensor to obtain information from the mail piece.

6. The mailing machine according to claim 1, further comprising:
a postage machine module operatively connected to the first processor, wherein,
the postage machine module is configured to print an appropriate postage indicium as indication of carrier selection preference.

7. The mailing machine according to claim 1, further comprising:
a sorting module having a plurality of bins, wherein,
the mail piece is sorted to one of the plurality of bins according to the indication of carrier selection preference.

8. The mailing machine according to claim 1, wherein,
the indication of carrier selection preference comprises an indication of a plurality of carriers in a sequential delivery route.

9. The mailing machine according to claim 1, further comprising:
a label printer operatively connected to the first processor, wherein,
the label printer prints a label associated with the indication of carrier selection preference and applies the label to the mail piece.

10. The mailing machine according to claim 1, further comprising:
a database storing carrier selection preference data and carrier sort data, wherein,
the first processor is configured to select a first carrier from a plurality of available carriers using the carrier selection preference data and the carrier sort data.

11. A mailing machine for selecting a carrier from a group of available carriers for use in delivering a mail piece comprising:
a processor operatively connected to a database storing carrier selection preference data and carrier sort data;
a sorter having a plurality of bins,
wherein the processor is configured to select the carrier from the plurality of available carriers using the carrier selection preference data and the carrier sort data and to utilize the sorter to send the mail piece t one of the plurality of bins associated with the carrier.

12. The mailing machine according to claim 11, wherein,
the processor is configured to select the carrier using input obtained from reading a destination address printed on the mail piece.

13. The mailing machine according to claim 11, wherein,
the processor is configured to select the carrier using input obtained from a co-located processor.

14. The mailing machine according to claim 11, wherein,
the processor is configured to select the carrier using input obtained from a remote data center.

15. The mailing machine according to claim 11, further comprising:
an optical sensor operatively connected to the processor, wherein,
the processor is configured to select the carrier using input obtained from using the optical sensor to obtain information from the mail piece.

16. The mailing machine according to claim 11, further comprising:
a postage machine module operatively connected to the processor, wherein,
the postage machine module is configured to print an appropriate postage indicium on the mail piece corresponding to the carrier selection.

17. The mailing machine according to claim 11, wherein,
the carrier selection comprises an indication of a plurality of carriers in a sequential delivery route.

18. The mailing machine according to claim 17, further comprising:
a label printer operatively connected to the first processor, wherein,
the label printer prints an address label having an address associated with one of the plurality of carriers applies the label to the mail piece.
